(19) United States
(12) Patent Application Publication
(10) Pub. No.: US 2010/0037278 A1
(43) Pub. Date: Feb. 11, 2010

(54) APPARATUS AND METHOD FOR TRANSMITTING AND RECEIVING BROADCASTING INFORMATION

(75) Inventors: Hyun-Seok YU, Seoul (KR); Seok-Min HWANG, Seoul (KR); Min-Goo KIM, Hwaseong-si (KR); Hyun-Seok OH, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/535,197

(22) Filed: Aug. 4, 2009

(30) Foreign Application Priority Data
Aug. 5, 2008 (KR) 10-2008-0076391

(51) Int. Cl. H04N 7/173

(52) U.S. Cl. 725/110

(57) ABSTRACT

An apparatus and method for transmitting and receiving broadcasting information transmission in a Digital Video Broadcasting (DVB) system are provided. The method for transmitting broadcasting information includes dividing a Program Specific Information (PSI) and/or Service Information (SI) table received from an upper layer into a plurality of sections, generating section numbers with respect to the sections, channel-coding and interleaving the sections, generating a Transport Stream (TS) packet including at least one section, section information and channel coding information, and multiplexing the TS packet together with a data TS packet.

### PRIORITY

This application claims the benefit under 35 U.S.C. §119(a) of a Korean patent application filed in the Korean Intellectual Property Office on Aug. 5, 2008 and assigned Serial No. 10-2008-0076391, the entire disclosure of which is hereby incorporated by reference.

### BACKGROUND OF THE INVENTION

1. Field of the Invention

The present invention relates to an apparatus and method for transmitting and receiving broadcasting information. More particularly, the present invention relates to an apparatus and method for transmitting and receiving Program Specific Information (PSI) and Service Information (SI) in a Digital Video Broadcasting (DVB) system.

2. Description of the Related Art

Program Specific Information (PSI) and/or Service Information (SI) are necessary for services in a Digital Video Broadcasting (DVB) system. Terminals, which store information, may acquire a broadcasting system status, which tune to a specific service and illustrate how to use a specific service.

In the DVB system, a terminal or a receiver requires a Network Information Table (NIT) to receive the service. The NIT provides information about multiplexes of a Transport Stream (TS) of a given DVB network or about a corresponding broadcasting system.

After confirming the broadcasting system information using the NIT, the terminal or the receiver receives a Program Association Table (PAT). The PAT informs the terminal or the receiver of an association of a Packet IDentifier (PID), which is contained in a header of a TS packet, and a program number.

Upon receiving the PAT, the terminal or the receiver may determine a variable named Program Number and determine the PID according to the variable. The terminal or the receiver may then determine the PID of a Program Map Table (PMT) to receive.

When receiving TS packets corresponding to the PID of the PMT, the terminal or the receiver may also determine the PMT. The PMT provides information relating to which program elements constitute an intended program number and information relating to which PIDs the program elements are transmitted, which are described below.

A Service Description Table (SDT) provides information relating to a DVB service provider and service names. A Time and Data Table (TDT) provides time and date information. A Time Offset Table (TOT) provides time offset information. An Internet Protocol/Media Access Control (IP/MAC) Notification Table (INT) provides important table information relating to a location and availability of an IP stream which is transmitted in the DVB network.

By receiving the above-stated information, the receiver may acquire the IP stream desired by a user and offer a program service to view. The information (i.e., the tables) is segmented into one or more sections, which are not transmitted at a certain time. The segmented sections are divided into one or more TS packets and then transmitted.

FIG. 1 is a schematic diagram of a conventional PSI/SI transmission in a DVB system.

Referring to FIG. 1, each section comprises a current section number and a last section number. Accordingly, upon receiving the entire PSI/SI table, the receiver may know whether the reception is complete.

As described above, the service reception is possible only upon receiving all of the necessary PSI/SI tables in order of NIT-PAT-PMT-INT. Such PSI/SI tables are required not only at an initial phase, but also in a handover in the process of the reception. The receiver requires refreshing the PSI/SI to determine the modification of the transmitted PSI/SI information. Moreover, the PSI/SI tables are received again when the channel is changed.

Thus, the time taken to receive the PSI/SI tables may affect the time taken to hand over or to change the channel.

While receiving the TS packets, the receiver regards the packet received as the start of a section when a value of a Payload Unit Start Indicator (PUSI) of the header of the TS packet becomes 1.

When the section starts, all subsequent TS packets are received and stored. Accordingly, a “continuity_counter” value in the header of the TS packet increases by one, such as, 1, 2, 3, 4, 5, . . . .

When a certain value is omitted, the receiver regards the omitted value as a packet loss, discards the received packets and restarts the reception. When a continuous reception succeeds, the receiver stores the received packets. When the PUSI=1, the receiver regards the reception as the end of a section and the start of a new section.

A DVB-T/H system, more particularly, a DVB-H system, is subject to a signal loss in a wireless mobile environment for a certain time or subject to difficult data reception because of a fading channel distortion. Accordingly, a portion of the tables to receive in the DVB-H system may be lost. For example, each section, which contains a Cyclic Redundancy Check (CRC) code, may determine whether the reception succeeds or fails.

Referring back to FIG. 1, it is assumed herein that the fading distorts a part corresponding to the first section 110. The receiver may not acquire the table since the table information may be determined only by correctly receiving every section. Therefore, the receiver has to wait for a first section 110 of the corresponding table while continuously determining the PID of the TS packet. As a result, part of the TS packet may be continuously lost.

In contrast, conventional data in the DVB-H system is robust to a fading environment because conventional data of the DVB-H system, that is, an IP datagram, is protected with Multi-Protocol Encapsulation Forward Error Correction (MPE-FEC).

The upper signal PSI/SI is protected merely with a Reed-Solomon (RS) code of the TS packet, which is not appropriate against a complicated and exceptional wireless fading environment.

Furthermore, commercial terminals suffer from a similar slow channel change because of the above described problems, which increases complaints of users.

Therefore, a need exists for an apparatus and method for transmitting and receiving a PSI/SI table efficiently in a DVB system.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for transmitting and receiving broadcasting information.

Another aspect of the present invention is to provide an apparatus and a method for transmitting and receiving a Program Specific Information (PSI) and/or Service Information (SI) table in a Digital Video Broadcasting (DVB) system.

Yet another aspect of the present invention is to provide an apparatus and a method for enhancing a PSI/SI table transmitting and receiving capability through coding in a DVB system.

Still another aspect of the present invention is to provide an apparatus and a method for reducing a channel switch time in a DVB system.

A further aspect of the present invention is to provide an apparatus and a method for allowing reliable handover and reliable channel change in a time-varying fading channel under various physical constraints in a DVB system.

In accordance with an aspect of the present invention, a method for transmitting broadcasting information at a transmitter in a DVB system is provided. The method includes dividing a PSI and/or SI table received from an upper layer into a plurality of sections, generating section numbers with respect to the sections, channel-coding and interleaving the sections, generating a Transport Stream (TS) packet comprising at least one section, section information and channel coding information, and multiplexing the TS packet together with a data TS packet.

In accordance with another aspect of the present invention, an apparatus of a transmitter for transmitting broadcasting information in a DVB system is provided. The apparatus includes a section divider for dividing a PSI and/or SI table received from an upper layer into a plurality of sections, a section number manager for generating section numbers with respect to the sections respectively, a channel encoder for channel-coding the sections, an interleaver for interleaving the encoded data, a controller for generating a TS packet comprising at least one section, section information, and channel coding information, and a multiplexer for multiplexing the TS packet together with a data TS packet.

In accordance with yet another aspect of the present invention, a method for receiving broadcasting information at a receiver in a DVB system is provided. The method includes receiving a TS packet, when a Payload Unit Start Indicator (PUSI) of the TS packet is 1, receiving TS packets until the TS packet is received with the PUSI of 1, acquiring coding information and section information in the process of the TS packet reception, deinterleaving the received TS packets, decoding the deinterleaved TS packets using the coding information, and generating a PSI and/or SI table with the decoded TS packets using the section information.

In accordance with still another aspect of the present invention, an apparatus of a receiver for receiving broadcasting information in a DVB system is provided. The apparatus includes a Radio Frequency (RF) modem for receiving a TS packet, a header determiner for, when a PUSI of the TS packet is 1, receiving TS packets until the TS packet is received with the PUSI of 1, and for acquiring coding information and section information in the process of the TS packet reception, a deinterleaver for deinterleaving the received TS packets, a channel decoder for decoding the deinterleaved TS packets using the coding information, and a section manager for generating a PSI and/or SI table with the decoded TS packets using the section information.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments the present invention will become more apparent from the following detailed description taken in conjunction with the accompanying drawings, in which:

FIG. 1 is a schematic diagram of a conventional Program Specific Information/Service Information (PSI/SI) transmission in a Digital Video Broadcasting (DVB) system;

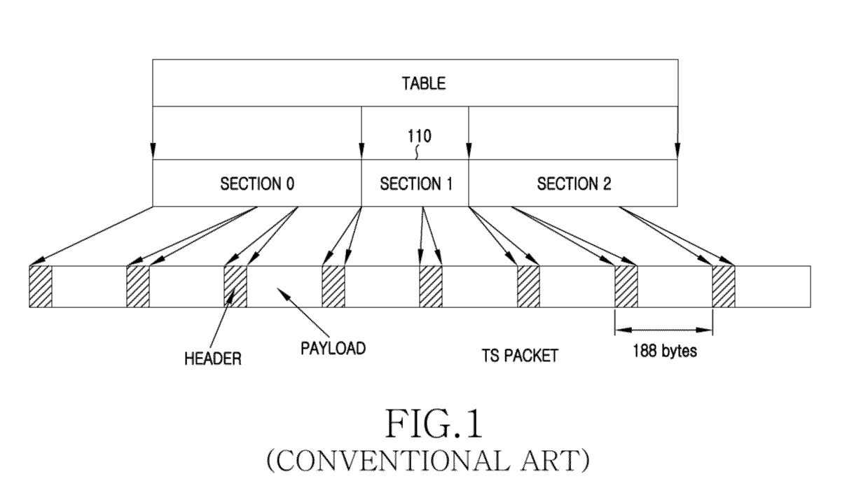

FIG. 2 is a diagram of a PSI/SI division transmission using tail bits according to an exemplary embodiment of the present invention;

FIG. 3 is a diagram of a PSI/SI division transmission using stuffing bits according to an exemplary embodiment of the present invention;

FIG. 4 is a block diagram of a Transport Stream (TS) generator of a transmitter according to an exemplary embodiment of the present invention;

FIG. 5 is a flowchart of operations of the TS generator of a transmitter according to an exemplary embodiment of the present invention;

FIG. 6 is a block diagram of a TS receiver of a receiver according to an exemplary embodiment of the present invention; and

FIG. 7 is a flowchart of operations of a TS receiver of a receiver according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide

Exemplary embodiments of the present invention provide apparatuses and methods for transmitting and receiving broadcasting information.

Digital Video Broadcasting (DVB)-Terrestrial/Handheld (T/H) is illustrated by way of example. An exemplary embodiment of the present invention provides a method for efficiently reinforcing protection of a Program Specific Information (PSI)/Service Information (SI) table while maintaining a relatively simple structure and not modifying a PSI/SI table structure similar to a conventional DVB system. An entire PSI/SI table passes through a channel coding with a separate block code to thus strengthen error correction capability and through a re-interleaving to provide a PSI/SI table that is robust to a fading channel.

However, in a Transport Stream (TS) packet reception, the end of a reception of a corresponding PSI/SI table is unknown. Thus, a receiver needs to recover sections by continuously receiving the TS packets and continues the reception until a “section_number” value of the section is equal to a “last_section_number” value.

Accordingly, the receiver requires the “section_number” value and “last_section_number” value, which are described below.

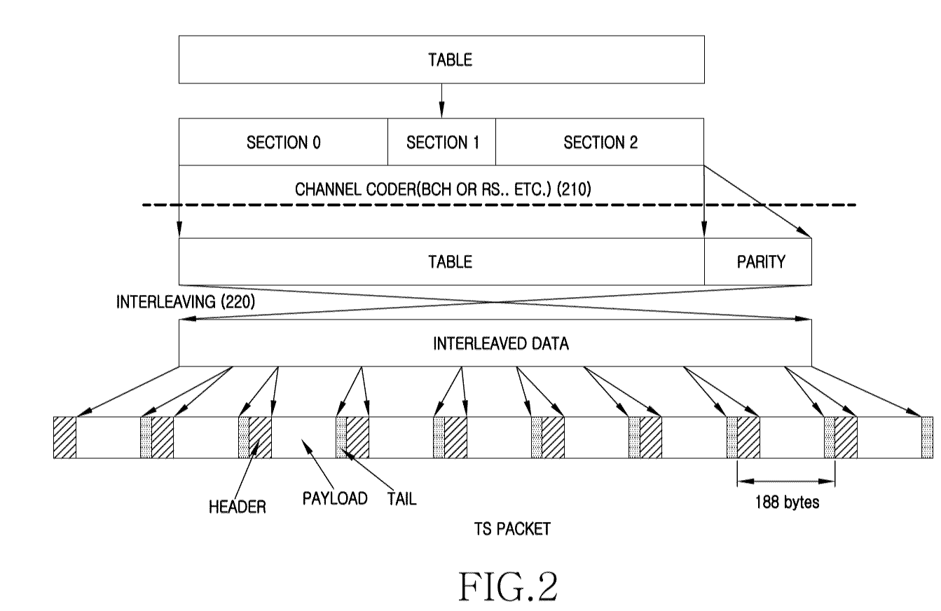

FIG. 2 illustrates a PSI/SI division transmission using tail bits according to an exemplary embodiment of the present invention.

Referring to FIG. 2, a block coding 210 is conducted on the PSI/SI table to reinforce an error correction capability, and an interleaving 220 is performed to provide a PSI/SI table that is robust to a fading channel.

In order for a receiver to determine a “section_number” value and a “last_section_number” value, a transmitter slightly reduces the size of a TS packet in a generation phase and inserts tail bits equivalent to the reduced size.

The tail bits indicate which section is a current packet (i.e., the section_number) and which section is a last section (i.e., last_section_number). Accordingly, the receiver acquires the entire reception information using the section information.

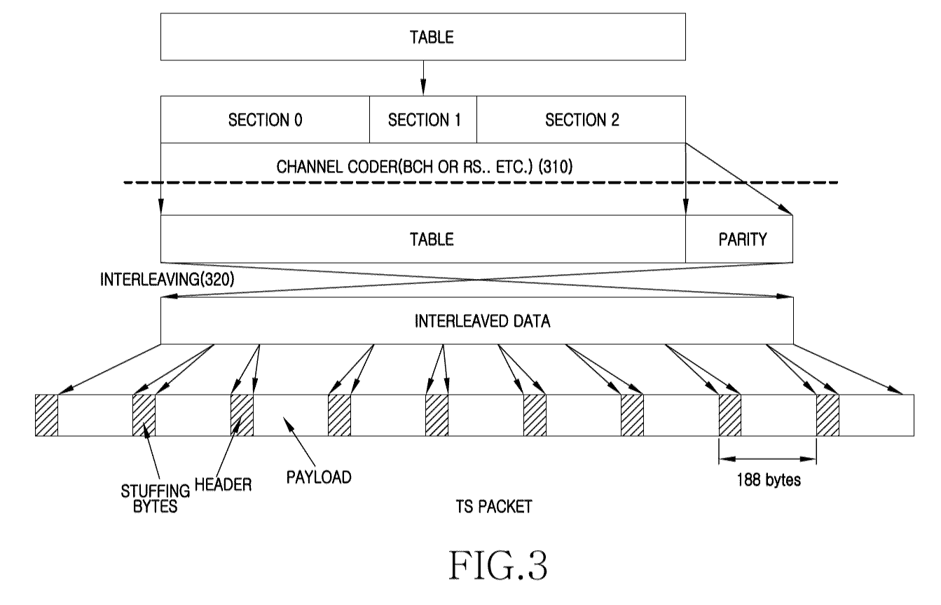

FIG. 3 illustrates a PSI/SI division transmission using stuffing bits according to an exemplary embodiment of the present invention.

As described above, a block coding 310 is conducted on the PSI/SI table to reinforce an error correction capability, and an interleaving 320 is performed to provide a PSI/SI table that is robust to the fading channel.

To enable the receiver to determine a “section_number” value and a “last_section number” value, a transmitter may use remaining stuffing bytes (8 bits) in a header of a TS packet, instead of separate tail bits. Herein, 4 bits are used to represent the “section_number” and lower 4 bits are used to represent the “last_section_number”, which conforms to a conventional Motion Picture Experts Groups (MPEG)-TS2 standard.

Since the receiver adopts the block coding for channel coding, it is necessary to acquire a total code length n and an information length value k, that is, the (n, k) value, for decoding. Since the length of the PSI/SI table is not consistently regular, information relating to the length of the PSI/SI table is needed.

Separately transmitting the (n, k) value may waste bands. Hence, the transmitter may generate a mapping table representing the (n, k) value and transmit only an index of the table using one of the stuffing bytes, which may be implemented in an exemplary embodiment of the present invention. Second and third packets carrying the PSI/SI table may deliver the table index.

Since the receiver has an error correction capability according to the channel coding, the receiver continues the reception until a Payload Unit Start Indicator (PUSI)=1, even when a “continuity_counter” value is not correct.

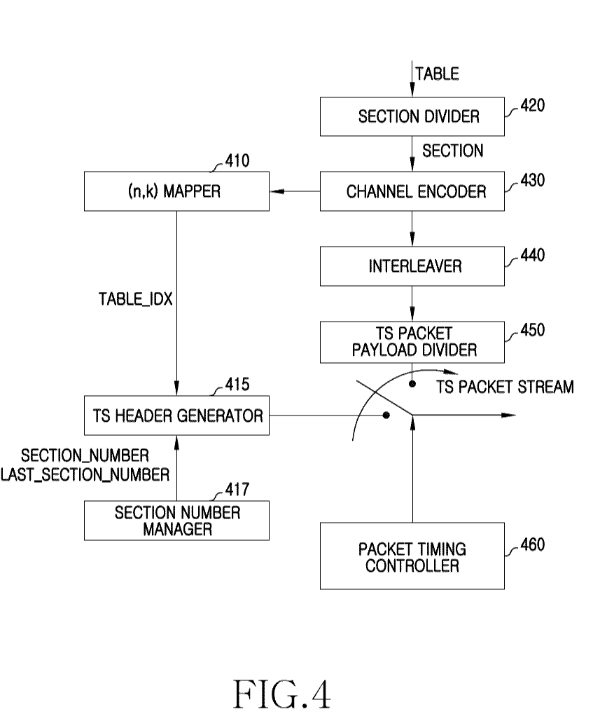

FIG. 4 is a block diagram of a TS generator of a transmitter according to an exemplary embodiment of the present invention.

Referring to FIG. 4, the TS generator generates a PSI/SI table. An output TS packet goes through multiplexing with a subsequent TS packet constituted as data. The multiplexing is carried out at a multiplexer.

Information of a Network Information Table (NIT), a Program Map Table (PMT) and a Program Association Table (PAT) from an upper layer is segmented into a plurality of sections by a section divider 420. Herein, contents of a section vary according to the type of PSI/SI table. Each section is segmented into TS payloads and added with a header to form a 188-byte TS packet.

A section number manager 417 provides a TS header generator 415 with section number information values, i.e., a “section_number” value and a “last_section_number” value in relation to the current section.

A channel encoder 430 channel-codes the sections output from the section divider 420. In an exemplary implementation, block coding is adopted for coding information. The coding information (n, k) used in the block coding is provided to a (n, k) mapper 410.

The (n, k) mapper 410 outputs the coding information (n, k) to a TS header generator 415.

The TS header generator 415 inserts the coding information (n, k) and the section number information into a stuffing bit region, or into a tail bit region. The coding information (n, k) from the TS header generator may be an index of the coding information (n, k).

The channel-coded sections are interleaved by an interleaver 440, input to a TS packet payload divider 450 and segmented into fixed-size payloads.

A packet timing controller 460 controls a switch according to the timing of the header output and the timing of the payload output, to incorporate the header output from the TS header generator 415 and the payload information output from the TS packet payload divider 450. The packet timing controller 460 may function as a transmission part for transmitting the packet.

Although not illustrated in FIG. 4, the controller may function as the component blocks 410 through 460. Herein, the component blocks 410 through 460 are separately provided to distinguish their respective functions.

However, the controller may process all or a portion of the functions of the component blocks 410 through 460.

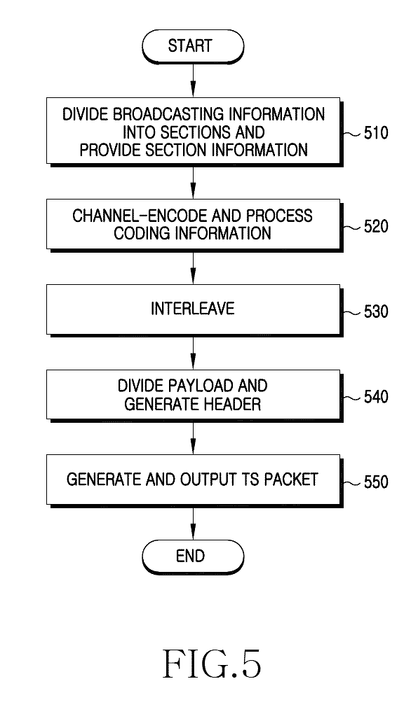

FIG. 5 is a flowchart of operations of a TS generator of a transmitter according to an exemplary embodiment of the present invention.

Referring to FIG. 5, the TS generator operates a PSI/SI table. An output TS packet passes through multiplexing together with the TS packet, which is constituted as data. The multiplexing is carried out at the multiplexer.

In step 510, broadcasting information, such as, NIT, PMT and PAT from an upper layer, is segmented into a plurality of the sections by a section divider. The section number manager provides the TS header generator with section number information (i.e., a “section_number” value and a “last section_number” value) with respect to a current section.

Herein, contents of the section vary depending on the type of PSI/SI table. Each section is segmented to form a TS packet payload. A header is added to the TS packet payload and thus, a 188-byte TS packet is constituted.

A channel encoder then channel-codes the sections output from the section divider. In an exemplary implementation, block coding is adopted. Coding information (n, k) used in the blocking code is provided to a (n, k) mapper. The (n, k) mapper provides the coding information (n, k) for the blocking code to the TS header generator in step 520.

In step 530, the channel-coded sections are interleaved at an interleaver. The interleaved sections are input to the TS packet payload divider and segmented into payloads of a uniform size. The TS header generator inserts the coding information (n, k) and the section number information values into a stuffing bit region or into a tail bit region in step 540.

A packet timing controller controls a switch according to the timing of the header output and the timing of the payload output, to incorporate the header output from a header manager and the payload information output from the TS packet payload in step 550.

The TS generator ends the process.

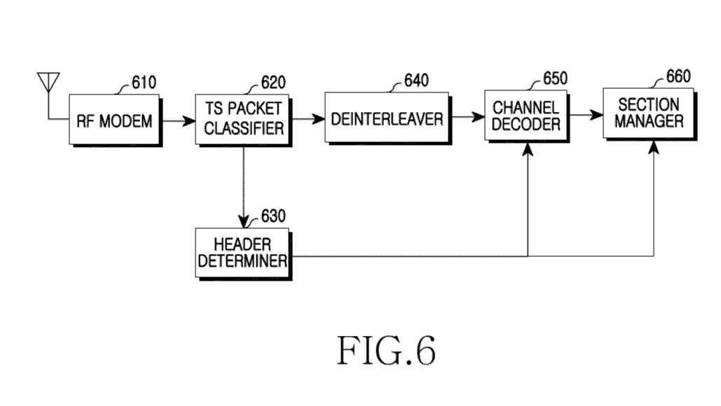

FIG. 6 is a block diagram of a TS receiver of a receiver according to an exemplary embodiment of the present invention.

Referring to FIG. 6, the TS receiver includes a Radio Frequency (RF) modem 610, a TS packet classifier 620, a header determiner 630, a deinterleaver 640, a channel decoder 650 and a section manager 660.

The RF modem 610 receives TS packets over an antenna. The TS packet reception comprises a radio signal reception, a baseband processing of the received radio signal, an analog-to-digital conversion and a demodulation.

The TS packet classifier 620 divides the received TS packet into a header and a payload, outputs the header to the header determiner 630, and outputs the payload to the deinterleaver 640.

The header determiner 630 acquires coding information and section information from the header and provides the acquired information to the channel decoder 650 and the section manager 660.

The header determiner 630 may acquire the coding information and the section information from a tail bit region or a stuffing bit region.

The deinterleaver 640 deinterleaves the payload and outputs the deinterleaved payload to the channel decoder 650.

The channel decoder 650 channel-decodes the payload using the coding information and outputs the decoded payload to the section manager 660.

The section manager 660 determines whether the current section is a last section including a PSI/SI table using the section information. When the current section is the last section, the section manager 660 generates and provides the PSI/SI table to an upper layer.

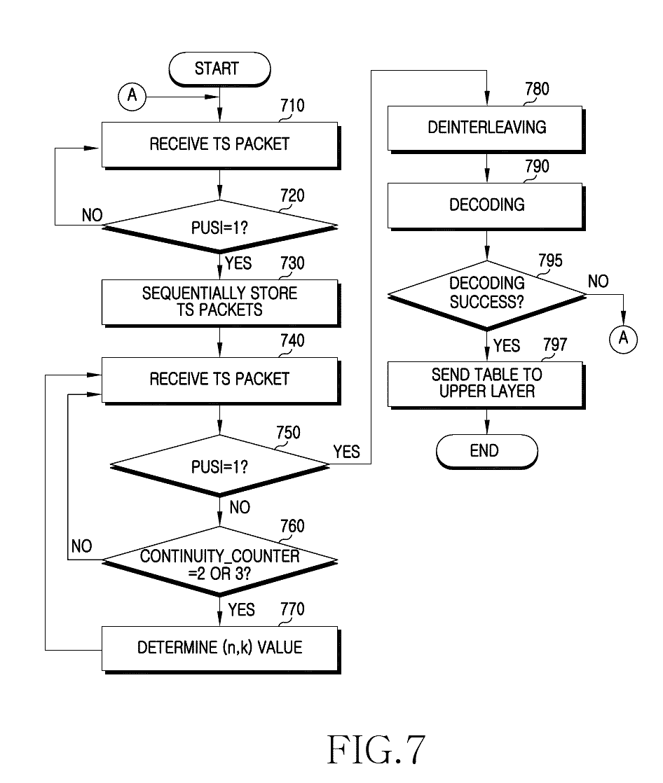

FIG. 7 is a flowchart of operations of a TS receiver of a receiver according to an exemplary embodiment of the present invention.

Referring to FIG. 7, in step 710, an RF modem receives a TS packet over an antenna. The TS packet reception comprises a radio signal reception, a baseband processing of the received radio signal, an analog-to-digital conversion and a demodulation.

A TS packet classifier divides the received TS packet into a header and a payload, outputs a header to the header determiner, and outputs the payload to a deinterleaver.

The header determiner acquires coding information and section information from the header, provides the coding information to a channel decoder, and provides the section information to a section manager. In more detail, the header determiner may acquire the coding information and the section information from a tail bit region or a stuffing bit region.

The header determiner examines a PUSI of the received TS packet. In step 720, if the PUSI value is not equal to ‘1’, that is, if the reception of the TS packet is not the start of a new section, the TS receiver continues receiving the TS packet in step 710 until the PUSI value is equal to ‘1’, that is, until the new section starts.

In step 730, if the PUSI value is equal to ‘1’, the new section reception starts. Accordingly, the TS receiver stores the received TS packets in sequence in step 730. In step 740, the TS packet reception is repeated until the next PUSI value is equal to ‘1’ in step 750, that is, until the reception of the new section finishes.

In step 750, if second and third TS packets carrying a PSI/SI table deliver the coding information, the header determiner examines the PUSI value of the received TS packet. If the PUSI value is not equal to ‘1’, that is, if the reception of the current section is still in process, a “continuity_counter” value is examined in step 760. In step 770, if the “continuity_counter” value is equal to ‘2’ or ‘3’, the coding information (n, k) is determined and acquired. The coding information is provided to a channel decoder.

In step 750, if the TS packet is received with the PUSI value equal to ‘1’ and the reception of the new section is completed, the deinterleaver deinterleaves the payload in step 780.

In step 790, the channel decoder channel-decodes the payload using the coding information. In step 795, if the channel decoding is successful, the channel-decoded payload is output to a section manager.

In step 795, if the channel decoding fails, the TS reception resumes in step 710.

The section manager generates the PSI/SI table using the section information and the channel-decoded payload, and provides the PSI/SI table to the upper layer in step 797.

The TS receiver ends the process.

As described above, an efficient PSI/SI table transmission and a rapid reception are accomplished in a DVB system. In a time-varying fading channel under various physical constraints, reliable handover and a fast channel switch may be implemented. Further, the channel change time in the DVB system may be shortened.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for transmitting broadcasting information at a transmitter in a Digital Video Broadcasting (DVB) system, the method comprising:
dividing a Program Specific Information (PSI) and/or Service Information (SI) table received from an upper layer into a plurality of sections;
generating section numbers with respect to the sections;
channel-coding and interleaving the sections;
generating a Transport Stream (TS) packet comprising at least one section, section information and channel coding information; and
multiplexing the TS packet together with a data TS packet.

2. The method of claim 1, wherein the interleaved sections are segmented into payloads of a uniform size.

3. The method of claim 1, wherein the generating of the TS packet comprises:
generating the at least one section as a payload of the TS packet;
adding the section information and the channel coding information to a stuffing region of a TS packet header; and
generating the TS packet by incorporating the TS packet payload and the TS packet header.

4. The method of claim 1, wherein the generating of the TS packet comprises:
generating the at least one section as a payload of the TS packet;
adding the section information and the channel coding information to tail bits of the TS packet;
generating a TS packet header; and
generating the TS packet by incorporating the TS packet header, the TS packet payload and the TS packet tail bits.

5. The method of claim 1, wherein the section information comprises a current section number and a last section number of the TS packet.

6. An apparatus of a transmitter for transmitting broadcasting information in a Digital Video Broadcasting (DVB) system, the apparatus comprising:
a section divider for dividing a Program Specific Information (PSI) and/or Service Information (SI) table received from an upper layer into a plurality of sections;
a section number manager for generating section numbers with respect to the sections;
a channel encoder for channel-coding the sections;
an interleaver for interleaving the encoded data;
a controller for generating a Transport Stream (TS) packet comprising at least one section, section information and channel coding information; and
a multiplexer for multiplexing the TS packet together with a data TS packet.

7. The apparatus of claim 6, further comprising a TS packet payload divider for segmenting the interleaved encoded data into payloads of a uniform size.

8. The apparatus of claim 6, wherein the controller generates the at least one section as a payload of the TS packet, adds the section information and the channel coding information to a stuffing region of a TS packet header, and generates the TS packet by incorporating the TS packet payload and the TS packet header.

9. The apparatus of claim 6, wherein the controller generates the at least one section as a payload of the TS packet, adds the section information and the channel coding information to tail bits of the TS packet, generates a TS packet header, and generates the TS packet by incorporating the TS packet header, the TS packet payload, and the TS packet tail bits.

10. The apparatus of claim 6, wherein the section information comprises a current section number and a last section number of the TS packet.

11. A method for receiving broadcasting information at a receiver in a Digital Video Broadcasting (DVB) system, the method comprising:
receiving a Transport Stream (TS) packet;
when a Payload Unit Start Indicator (PUSI) of the TS packet is 1, receiving TS packets until the TS packet is received with the PUSI of 1;
acquiring coding information and section information in the process of the TS packet reception;
deinterleaving the received TS packets;
decoding the deinterleaved TS packets using the coding information; and
generating a Program Specific Information (PSI) and/or Service Information (SI) table with the decoded TS packets using the section information.

12. The method of claim 11, further comprising dividing the TS packets into a header and a payload.

13. The method of claim 11, wherein the coding information and the section information are acquired from at least one of a tail bit region and a stuffing bit region.

14. The method of claim 11, wherein the section information comprises a current section number and a last section number of the TS packet.

15. The method of claim 11, wherein the generating of the PSI/SI table comprises, when the current section is the last section, generating the PSI/SI table.

16. An apparatus of a receiver for receiving broadcasting information in a Digital Video Broadcasting (DVB) system, the apparatus comprising:
a Radio Frequency (RF) modem for receiving a Transport Stream (TS) packet;
a header determiner for, when a Payload Unit Start Indicator (PUSI) of the TS packet is 1, receiving TS packets until the TS packet is received with the PUSI of 1, and for acquiring coding information and section information in the process of the TS packet reception;
a deinterleaver for deinterleaving the received TS packets;
a channel decoder for decoding the deinterleaved TS packets using the coding information; and
a section manager for generating a Program Specific Information (PSI) and/or Service Information (SI) table with the decoded TS packets using the section information.

17. The apparatus of claim 16, further comprising a TS divider for dividing the TS packets into a header and a payload.

18. The apparatus of claim 16, wherein the header determiner acquires the coding information and the section information from at least one of a tail bit region and a stuffing bit region.

19. The apparatus of claim 16, wherein the section information is a current section number and a last section number of the TS packet.

20. The apparatus of claim 16, wherein, when the section information indicates that the current section is the last section, the section manger generates the PSI/SI table.
